(19) United States
(12) Patent Application Publication
(10) Pub. No.: US 2016/0236544 A1
(43) Pub. Date: Aug. 18, 2016

(54) Automotive rearview mirror support-post-mounted glare shield

(71) Applicant: Michael Eugene Doyle, St. Augustine, FL (US)

(72) Inventor: Michael Eugene Doyle, St. Augustine, FL (US)

(21) Appl. No.: 14/579,687

(22) Filed: Dec. 22, 2014

Related U.S. Application Data
(60) Provisional application No. 61/926,288, filed on Jan. 11, 2014.

(51) Int. Cl. B60J 3/02

(52) U.S. Cl. CPC B60J 3/02; B60R 1/12

(57) ABSTRACT

A sun glare shield which attaches to the rearview mirror mounting post of most passenger vehicles to block unwanted sunlight that comes in around the rearview mirror when driving into a low sun, designed to prevent the driver from being blinded by the glare. The glare shield consists of one planer panel of foam rubber with a slot coming up from the bottom, in the center, to slide over and grip the rearview mirror's mounting post.

### CROSS-REFERENCE TO RELATED APPLICATIONS

| | | |
|---|---|---|
| 2,033,391 | March 1936 | Muench |
| 2,163,495 | June 1939 | Levy |
| 2,549,395 | April 1951 | Short |
| 2,620,222 | December 1952 | Beauchamp |
| 4,172,613 | October 1979 | Furando |
| 4,275,917 | June 1981 | Marcus |
| 4,958,879 | September 1990 | Gillum |
| 5,333,927 | August 1994 | PreJean |
| 5,494,328 | February 1996 | Lehr |
| 5,575,523 | November 1996 | Keller |
| 5,810,419 | September 1998 | Lam |
| 5,979,967 | November 1999 | Poulson |
| 6,296,294 | October 2001 | Kohnle et al. |
| 6,513,855 | February 2003 | Zenisek |

### STATEMENT REGARDING FEDERALLY SPONSORED RESEARCH OR

DEVELOPMENT

Not applicable

### REFERENCE TO SEQUENCE LISTING, ETC.

Not applicable

### BACKGROUND OF THE INVENTION

1. Field of Invention

The present invention relates to automobile sun glare shields and specifically to those that attach to the rearview mirror mounting post. It is directed to solve the problem of unwanted and dangerous glare that shines into a vehicle around the rearview mirror when driving into the sun when it is low in the sky. Since such glare frequently causes accidents on the road, some fatal, the invention squarely belongs in the category of an automotive safety accessory.

2. Description of Prior Art

Most automobiles are equipped with two sun visors that are folded up against the headliner of the vehicle when not in use. When used, the sun visors are turned down to block the incoming glare of the sun; but they are configured in such a manner, when turned down, not to interfere with or block the view of the rearview mirror. When the visors are in use, a portion of the windshield surrounding the rearview mirror is not covered so the glare of the sun is also not blocked. As a result, a driver can be virtually blinded by the sun's glare. This is not a new problem; in fact, U.S. Pat. No. 2,033,391 to H. E. Muench on Mar. 10, 1936 was an early attempt to reduce or eliminate the glare that comes in around the rearview mirror.

In the ensuing years many attempts have been made to improve upon Muench's first solution. For example, U.S. Pat. No. 2,163,495 to S. M. Levy (Jun. 20, 1939) shows two glare shields that pivot down into place to block the glare of the sun. These glare shields are attached to hardware that is in turn attached to the rearview mirror mounting bracket. U.S. Pat. No. 2,620,222 to M. E. Beauchamp (Dec. 2, 1952) shows a shield that clips to a bracket mounted to the upper windshield frame. U.S. Pat. No. 4,172,613 to J. V. Furando (Oct. 30, 1979) shows a glare shield that mounts to the windshield with suction cups. U.S. Pat. No. 4,275,917 to K. H. Marcus (Jun. 30, 1981) shows a glare shield assembly that is attached to the inside of the roof of the vehicle. U.S. Pat. No. 5,494,328 to J. J. Lehr (Feb. 27, 1996) shows a glare shield mounted by hardware attached to the windshield frame and a suction cup. All of the above solutions require some type of permanent mounting to the windshield metalwork or suction cups.

Another approach taken by others is to use the rearview mirror mounting post as the support for the glare shield. For example: U.S. Pat. No. 2,549,395 to C. A. Short Sr. (Apr. 17, 1951) shows a shield that has a slot with several circular apertures that allow it to hang on the rearview mirror mounting post. U.S. Pat. No. 4,958,879 to J. H. Gillum (Sep. 25, 1990) shows a folding shield with a mounting slot that slips over the rearview mounting post to balance thereon. U.S. Pat. No. 5,333,927 to R. M. PreJean (Aug. 2, 1994) shows a multi-functional sun shielding and storage device that mounts with a suction cup while resting on the rearview mirror support post. U.S. Pat. No. 5,575,523 to T. F. Keller (Nov. 19, 1996) shows a swinging shield mounted to the rearview mirror support post with a clamping mechanism. U.S. Pat. No. 5,810,419 to K. Lam (Sep. 22, 1998) shows a shield that is directly attached to the rearview mirror by a bracket. U.S. Pat. No. 5,979,967 to T. C. Poulson (Nov. 9, 1999) also shows a shield that is directly attached to the rearview mirror with hook and loop fasteners. U.S. Pat. No. 6,296,294B1 issued to K. F. Kohnle and M. E. Bouches (Oct. 2, 2001) shows a shield attached to the rearview mirror mounting post using a hook and loop fastener to close the panel around and secure to the mounting post.

The latest attempt to solve to the problem of unwanted glare above and around the rearview mirror is U.S. Pat. No. 6,513,855 issued to Robert F. Zenisek (Feb. 4, 2003), which shows a shield attached to the rearview mirror mounting post at any one of a number of designated pop-out locations by being clamped by opposing panels and secured with boss and key.

A search of the Internet, national auto parts retailers, and large general merchandise retailers revealed that none of the above solutions are currently on the market. All of the prior art appears capable of fulfilling the basic function of blocking the glare of the sun (albeit with some drawbacks), but since none are currently on the market, the problem of sun glare around the mirror remains with no solution currently available to the consumer.

Since unwanted sun glare is usually a temporary (although repeated) driving annoyance, the average driver is probably not motivated to invest a large amount of effort or expense in solving the problem. However, the results of not addressing the problem can be severe and even deadly, and many commuters face it almost daily. Therefore, without knowing anything about the marketing successes and failures of each of the prior solutions, it can only be assumed that convenience, functionality, price, and appeal were not sufficiently attractive for any of them to sell in quantities sufficient to remain on the market. Therefore, the challenge of the present invention is to enable the production of a glare shield that consumers will actually purchase and use. It is believed that a glare shield having the following specifications would be successful: (1) does not require any installation process, (2) is easy to mount and remove, (3) mounts securely without slippage as a result of the vehicle's vibration or bouncing, (4) fits a large portion of the passenger vehicles on the road, (5) is available at an attractive and affordable retail price, and (6) has a pleasing appearance and feel.

### BRIEF SUMMARY OF THE INVENTION

The preferred embodiment of the present invention is a rectangular planer panel of flexible material with a slot coming up from the bottom, in the central region, to slide over and grip the rearview mirror mounting post. The slot allows the glare shield to be slid up or down on the mirror's support post, as well as forward or back along the same support post, as well as tilted, to obtain the best position for blocking the sun while maintaining a clear view of the roadway.

The present invention is wide enough to fill the gap between the standard flip-down visors and tall enough to block unwanted glare of the sun from coming in above and below the rearview mirror when driving into the sun when it is low in the sky. When the present invention is not needed, it can be easily removed and stored ready for the next need.

The present invention seeks to overcome the probable lack of salability of previous solutions by (1) not requiring any preparation or installation before use; (2) being adjustable for functionality; (3) being one piece for manufacturing simplicity and requiring only two inexpensive production steps; and (4) being made out of a material that is reasonably priced for affordability, flexible to fit a large variety of vehicles, and pleasing in look and feel for customer appeal.

### BRIEF DESCRIPTION OF THE SEVERAL VIEWS OF THE DRAWING

### Brief Description of the Drawings

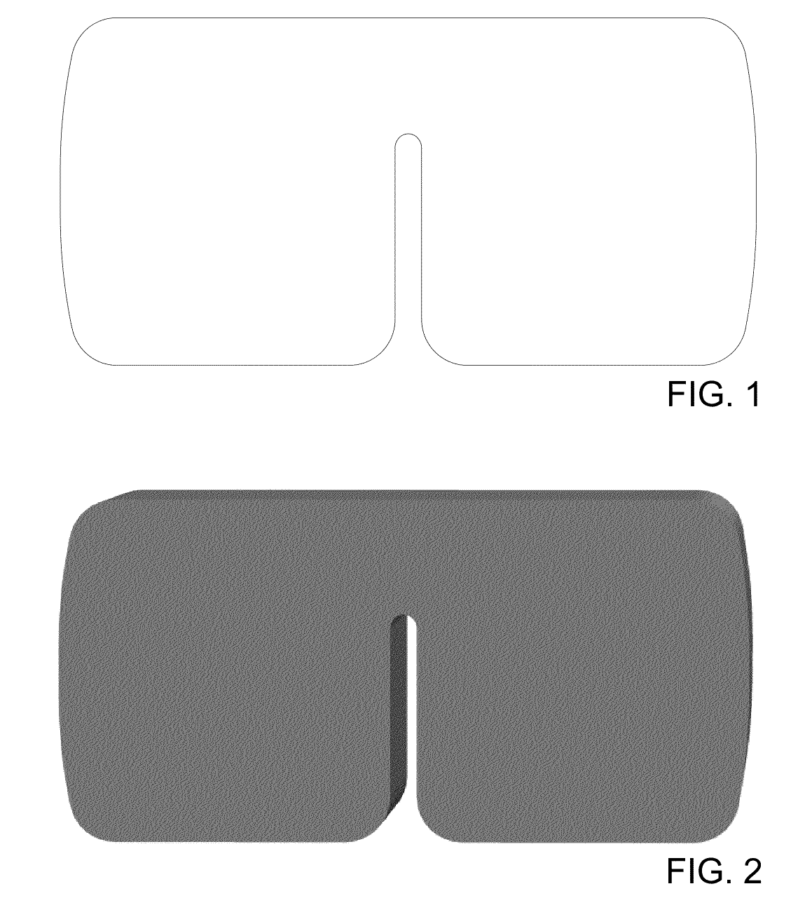

FIG. 1 is the outline of the present invention.

FIG. 2 is a perspective view of the present invention

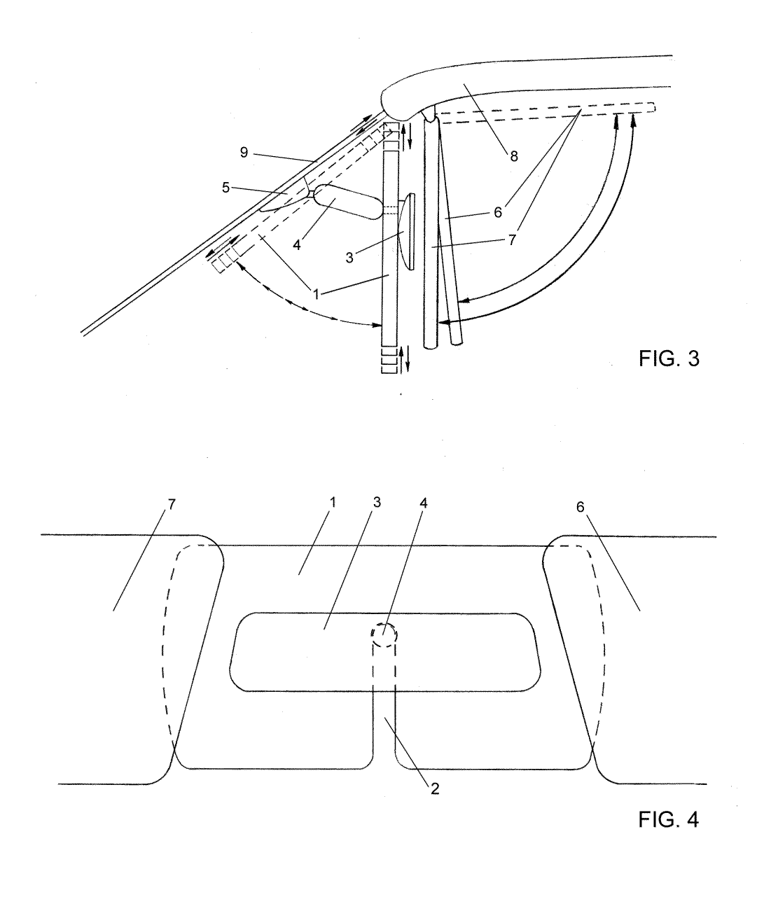

FIG. 3 shows a side view of the present invention 1 mounted on the rearview mirror support post 4 that is attached to windshield 9 by windshield mount 5, and behind the rearview mirror 3 and behind typical automotive sun visors 6 and 7, which are attached to the roof 8.

FIG. 4 shows a view from inside the vehicle of the present invention 1 mounted from above and behind rearview mirror 3 by way of the mounting slot 2 onto the rearview mirror support post 4 and behind the right sun visor 6 and left sun visor 7.

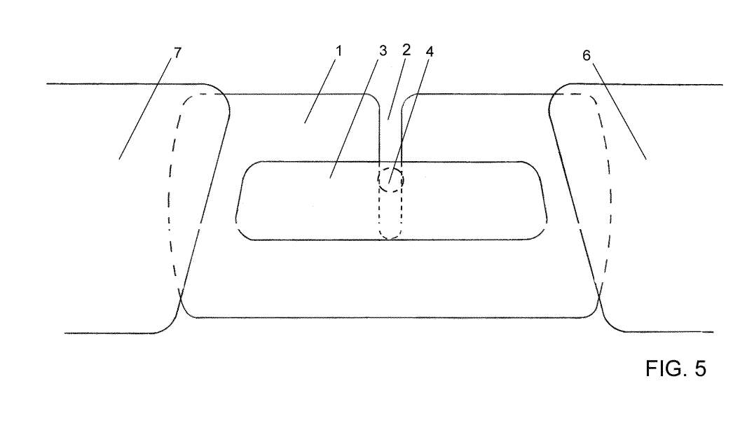

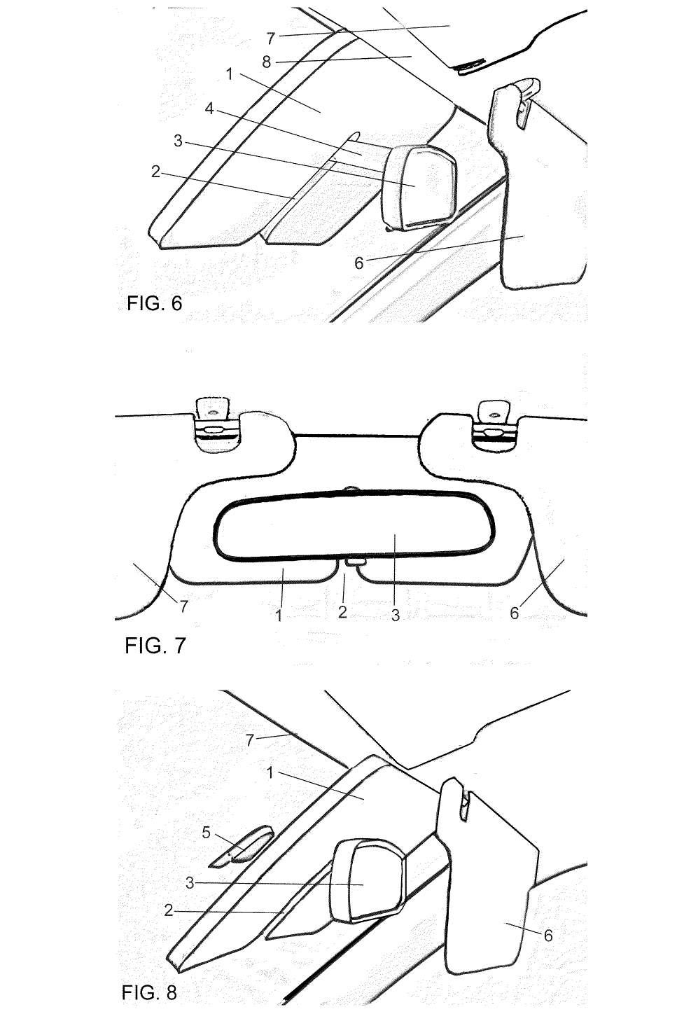

FIG. 5 shows a view from inside the vehicle of the present invention 1 mounted from below and behind rearview mirror 3 by way of the mounting slot 2 onto the rearview mirror support post 4 and behind the right sun visor 6 and left sun visor 7.

Reference numbers in the drawings: 1 Glare shield; 2 Mounting slot; 3 Rearview mirror; 4 Rearview mirror support post; 5 Rearview mirror windshield mount; 6 Typical automotive right sun visor; 7 Typical automotive left sun visor; 8 Roof of vehicle; 9 Windshield.

### DETAILED DESCRIPTION OF THE INVENTION

The preferred embodiment of the present invention, the glare shield, is a rectangular planer panel of a flexible and resilient material, with a slot (FIG. 1 and FIG. 2) coming up from the bottom (FIG. 4) or down from the top (FIG. 5) of the panel depending upon the orientation of the panel, which is optional. The slot is slightly smaller than the diameter of the rearview mirror mounting post and enables the glare shield to be slid onto and grip the mounting post. The length of the slot is such that the glare shield may be adjusted to suit the height of the driver (or passenger) and the position of the sun by sliding the shield up and down and back and forth (FIG. 3) on the rearview mirror mounting post. The specific dimensions of the said rectangular planer panel and the specific location, length, and width of the slot are not significant because the dimensions of the glare shield will vary to suit different vehicles, specifically, the distance between the standard flip-down visors and the variety of sizes and shapes of rearview mirror support posts.

The flexibility and resilience of the foam rubber material enable the slot in the planar panel, being narrower than the diameter of the rearview mirror support post, to apply pressure on the post to create a friction grip between the edges of the slot and the post. This allows the planar panel to hug the rearview mirror support post anywhere along the length of the post and anywhere along the length of the slot for an infinite number of possible positions.

FIG. 3 shows a typical rearview mirror assembly including the rearview mirror 3, rearview mirror mounting post 4, and windshield mount 5 and the infinite number of positions that the glare shield may be placed in to accommodate the sun at different angles in the sky and the different eye-level heights of drivers, to wit, by movement of the glare shield up and down, back and forth, and the combination of those movements.

FIG. 4 shows the option of mounting the glare shield from above the rearview mirror and FIG. 5 shows the option of mounting the glare shield from below.

The flexibility of the planar panel also enables it, when needed, to curve around the rearview mirror and the windshield in route to the desired position on the mounting post.

All prior art required some preparation for using the glare shield, mostly through the use of various fastening methods, sometimes complex, to attach the glare shield to the rearview mirror support post, to the vehicle's visors, or to the underside of the roof of the vehicle. Those fastening methods included screws, suction cups, hook-and-loop fasteners, and adhesives. The present invention has avoided the need for preparation and parts installation through the simple use of the friction fit between the foam of the glare shield and the rearview mirror mounting post.

The present invention called for a material that would maintain its position when mounted on the rearview mirror support post and not droop when left in a hot car. The material would need to be lightweight to minimize the friction needed to hold the glare shield in place without having to add to the surface area to improve the grip.

The material that best fulfilled these requirements is standard density, closed-cell, cross-linked foam, although a variety of materials, including but not restricted to other foam, would also meet the minimum requirements. Use of this foam also enables the fulfillment of the objective of being easy and inexpensive to manufacture because the glare shield is made by a two-step process: the standard process of slicing a sheet of foam to the desired thickness and then die-cutting the sliced foam to produce the glare shield.

The advantages then include (1) the ability to use the glare shield, without any preparation or parts installation, through the simple use of friction that allows the glare shield to grip the rearview mirror support post; (2) flexibility so the glare shield may be used in a larger number of vehicles, particularly including those vehicles with only a small space between the rearview mirror, headliner, and windshield that would preclude the use of a rigid glare shield; and (3) the ability to position the glare shield in a variety of ways to suit the position of the sun in the sky and the height of different drivers.

I claim:

1. A glare shield for attachment to a passenger vehicle's rearview mirror mounting post, comprising
a rectangular member having a generally flat, flexible body
an elongated longitudinal slot in the member, with said slot having at one end an entry mouth along one of the latitudinal edges of the member and terminating at the other end within the body of the member,
said slot having a width smaller than the diameter of the rearview mirror mounting post for which it has been designed.

2. The glare shield of claim 1 wherein the slot has parallel sides that engage the surface of the rearview mirror support post to support the body of the member by the friction between the rearview mirror support post and parallel sides of the slot in the member.
